(19) United States
(12) Patent Application Publication
(10) Pub. No.: US 2022/0195258 A1
(43) Pub. Date: Jun. 23, 2022

(54) DOUBLE-SIDED PRESSURE-SENSITIVE ADHESIVE SHEET, POLISHING MEMBER, AND SURFACE PLATE WITH POLISHING PAD

(71) Applicants: TOYO INK SC HOLDINGS CO., LTD., Tokyo (JP); TOYOCHEM CO., LTD., Tokyo (JP)

(72) Inventor: Tadashi ABE, Tokyo (JP)

(73) Assignees: TOYO INK SC HOLDINGS CO., LTD., Tokyo (JP); TOYOCHEM CO., LTD., Tokyo (JP)

(21) Appl. No.: 17/551,645

(22) Filed: Dec. 15, 2021

(30) Foreign Application Priority Data
Dec. 18, 2020 (JP) 2020-209851

(51) Int. Cl. C09J 7/38; B32B 7/12; B32B 5/18; B32B 5/02; B32B 5/32; B32B 5/24; B32B 5/26

(52) U.S. Cl. CPC C09J 7/385; B32B 7/12; B32B 5/18; B32B 5/022; B32B 5/32; B32B 2266/025; B32B 5/266; C09J 2301/124; C09J 2301/122; B32B 2266/0278; B32B 5/245

(57) ABSTRACT

The double-sided pressure-sensitive adhesive sheet according to one aspect is a double-sided pressure-sensitive adhesive sheet for bonding a polishing pad to a surface plate, for bonding a polishing member to the surface plate, or for forming the polishing member, the pressure-sensitive adhesive sheet including a sheet-shaped base material, and a first pressure-sensitive adhesive layer and a second pressure-sensitive adhesive layer provided on each main surface of the base material, where at least one of the first adhesive layer and the second adhesive layer is a pressure-sensitive adhesive layer that is formed from a pressure-sensitive adhesive including an acrylic-based copolymer having a specific composition and a specific molecular weight, a tackifier resin having a specific amount, and a tolylene diisocyanate trimethylolpropane adduct, the pressure-sensitive adhesive layer having a gel fraction of 5 to 50% by mass.

### PRIORITY CLAIM

This application is based upon and claims the benefit of priority from Japanese patent application No. 2020-209851, filed on Dec. 18, 2020, the disclosure of which is incorporated herein in its entirety by reference.

### BACKGROUND

The present disclosure relates to a double-sided pressure-sensitive adhesive sheet. More specifically, the present disclosure relates to a double-sided pressure-sensitive adhesive sheet for forming a polishing member. In addition, the present disclosure relates to a double-sided pressure-sensitive adhesive sheet for fixing (bonding) a polishing member or a polishing pad to a surface plate. In addition, the present disclosure relates to a polishing member provided with a double-sided pressure-sensitive adhesive sheet and a surface plate with a polishing pad.

For polishing silicon wafers or glass, there is used a polishing pad or a polishing member having at least a laminated structure of a polishing pad/pressure-sensitive adhesive sheet/intermediate layer. The intermediate layer is a layer disposed between the polishing pad and the surface plate, and is bonded to the surface plate via the pressure-sensitive adhesive layer. The intermediate layer serves equalizing the polishing pressure, and therefore can also be called a cushion layer. The polishing pad and the polishing member are used with being fixed to the polishing machine surface plate, and a pressure-sensitive adhesive sheet is used as the fixing means. In addition, as described above, the pressure-sensitive adhesive sheet is used as a pressure-sensitive adhesive sheet for fixing the polishing pad and the intermediate layer.

For example, Japanese Unexamined Patent Application Publication No. 2017-008158 (Patent Literature 1) has disclosed a (meth)acrylic pressure-sensitive adhesive that includes a (meth)acrylic material in which cross-linking of a cross-linking composition including a (meth)acrylic copolymer and a cross-linking agent had proceeded, and that has a gel fraction of 53% by mass or more.

Japanese Unexamined Patent Application Publication No. 2017-105976 (Patent Literature 2) has disclosed a pressure-sensitive adhesive sheet that includes a polymerized rosin-based tackifier resin having 3 parts by mass or more and 40 parts by mass or less with respect to 100 parts by mass of the acrylic-based polymer.

Japanese Unexamined Patent Application Publication No. 2014-019801 (Patent Literature 3) has disclosed a pressure-sensitive adhesive tape that includes, on one side surface thereof, a pressure-sensitive adhesive layer using an acrylic-based resin and a pressure-sensitive adhesive (A) containing a tackifier resin (x) having a rosin ester skeleton and a tackifier resin (y) having an aromatic petroleum-based resin skeleton in a specific ratio.

Japanese Unexamined Patent Application Publication No. 2015-078348 (Patent Literature 4) has disclosed a pressure-sensitive adhesive sheet that includes a pressure-sensitive adhesive layer including a styrene-based block copolymer.

### SUMMARY

The polishing step is problematic in that the polishing pad and the polishing member are peeled off from or positioned improperly on the surface plate because a strong shearing force is applied to the pressure-sensitive adhesive layer constituting the pressure-sensitive adhesive sheet and the temperature becomes high during polishing. In addition, it is problematic in that the polishing pad constituting the polishing member is peeled off from or positioned improperly on the intermediate layer. Therefore, the pressure-sensitive adhesive layer for fixing the polishing pad and the polishing member to the surface plate is required to have a strong pressure-sensitive adhesive force to the polishing pad and the surface plate, or to the intermediate layer constituting the polishing member and the surface plate from a room temperature to high temperatures, and is further required to have a cohesive force capable of withstanding the shearing force during polishing. Similarly, the pressure-sensitive adhesive layer constituting the polishing member is required to have a strong pressure-sensitive adhesive force to the polishing pad and the intermediate layer from a room temperature to high temperatures, and is also required to have a cohesive force capable of withstanding the shearing force during polishing. The cohesive force is often evaluated by a holding force test.

The pressure-sensitive adhesive sheet described in Patent Literature 1 has excellent holding force and pressure-sensitive adhesive force in high temperatures; however, has a small holding force and pressure-sensitive adhesive force around a room temperature and is easily peeled off, and thus is problematic in that the polishing state at the initial stage of polishing is unstable.

On the other hand, in Patent Literature 2, the pressure-sensitive adhesive sheet described has excellent pressure-sensitive adhesive force and holding force at low temperature, and it is described that the pressure-sensitive adhesive force to the stainless steel plate at 23° C., 13° C., and −10° C. and the holding force to the phenol plate at 40° C. under a load of 500 g are evaluated. However, the foamed sheet used for the polishing pad has smaller contact area with the pressure-sensitive adhesive layer than that of the stainless steel plate because of foaming. Therefore, the pressure-sensitive adhesive sheet described in Patent Literature 2 is problematic in that the pressure-sensitive adhesive force to the foamed sheet is hardly be developed. In addition, the pressure-sensitive adhesive sheet described in Patent Literature 2 is problematic in that the holding force at high temperatures and a high load is insufficient.

In addition, the pressure-sensitive adhesive sheet described in Patent Literature 3 has excellent holding force at high temperatures to some extent for a relatively short time; however, is problematic in that when exposed to high temperatures for a long time after being bonded, insufficient holding force can be maintained or developed.

Furthermore, the pressure-sensitive adhesive sheet before bonding has been required to have the same performance after bonding as the bonding performance of the pressure-sensitive adhesive sheet before storage (temporal stability as a pressure-sensitive adhesive sheet) even when stored for a long time in a high-temperature environment or a high-temperature and high-humidity environment.

The present disclosure is a double-sided pressure-sensitive adhesive sheet for polishing, and the object thereof is to provide the double-sided pressure-sensitive adhesive sheet that can develop strong pressure-sensitive adhesive force from a room temperature to high temperatures and can develop sufficient holding force for a long time at high temperatures, a polishing member, and a surface plate with a polishing pad. Furthermore, an object of the present disclosure is to provide a double-sided pressure-sensitive adhesive sheet that can develop and maintain pressure-sensitive adhesive force and holding force comparable to those before storage and has excellent temporal stability even when the double-sided pressure-sensitive adhesive sheet before bonding is stored for a long time in a high-temperature environment or a high-temperature and high-humidity environment, a polishing member, and a surface plate with a polishing pad.

As a result of intensive investigations, the present disclosers have found that the above problem can be solved in the following aspects, and have reached the present disclosure.

[1]: A double-sided pressure-sensitive adhesive sheet for bonding a polishing pad to a surface plate, for bonding a polishing member having the polishing pad to the surface plate, or for forming the polishing member, comprising:

a sheet-shaped base material;

a first pressure-sensitive adhesive layer provided on a first main surface of the sheet-shaped base material; and

a second pressure-sensitive adhesive layer provided on a second main surface of the sheet-shaped base material, wherein

both the first pressure-sensitive adhesive layer and the second pressure-sensitive adhesive layer are each independently, or any one of the first pressure-sensitive adhesive layer and the second pressure-sensitive adhesive layer is a pressure-sensitive adhesive layer that is formed from a pressure-sensitive adhesive including an acrylic-based copolymer (A), a tackifier resin (B), and an isocyanate compound (C), the pressure-sensitive adhesive layer having a gel fraction of 5 to 50% by mass,

the pressure-sensitive adhesive includes 15 to 50 parts by mass of the tackifier resin (B) with respect to 100 parts by mass of the acrylic-based copolymer (A),

the acrylic-based copolymer (A) is a copolymer of radically polymerizable monomers and having a weight average molecular weight of 600000 or more,

the radically polymerizable monomers include n-butyl (meth)acrylate, alkyl (meth)acrylate having 6 to 9 carbon atoms in an alkyl group, a radically polymerizable monomer having a carboxy group, and radically polymerizable monomers having a hydroxyalkyl group,

56% by mass or more of the n-butyl (meth)acrylate, 1 to 5% by mass of the radically polymerizable monomer having a carboxy group, and 0.01 to 0.3% by mass of the radically polymerizable monomers having a hydroxyalkyl group are included in 100% by mass of the radically polymerizable monomers,

90 to 100% by mass of a radically polymerizable monomer having a hydroxyalkyl group that has 3 or less carbon atoms is included in 100% by mass of the radically polymerizable monomers having a hydroxyalkyl group, and the isocyanate compound (C) is a tolylene diisocyanate trimethylolpropane adduct.

[2]: The double-sided pressure-sensitive adhesive sheet according to [1], wherein the pressure-sensitive adhesive includes 0.5 to 2.5 parts by mass of the isocyanate compound (C) with respect to 100 parts by mass of the acrylic-based copolymer (A).
[3]: The double-sided pressure-sensitive adhesive sheet according to [1] or [2], wherein a weight average molecular weight of the acrylic-based copolymer (A) is 600000 to 1400000.
[4]: The double-sided pressure-sensitive adhesive sheet according to any one of [1] to [3], wherein the tackifier resin (B) includes a polymerized rosin ester, and 50 to 100% by mass of the polymerized rosin ester is included in 100% by mass of the tackifier resin (B).
[5]: The double-sided pressure-sensitive adhesive sheet according to [4], wherein a softening point of the polymerized rosin ester is 135° C. or less.
[6]: A polishing member, comprising a polishing pad and an intermediate layer that are bonded via the double-sided pressure-sensitive adhesive sheet according to any one of [1] to [5].
[7]: A surface plate with a polishing pad, wherein a polishing pad and a surface plate are bonded via the double-sided pressure-sensitive adhesive sheet according to any one of [1] to [5].
[8]: A surface plate with a polishing pad, comprising:

a polishing member including a polishing pad and an intermediate layer; and a surface plate, wherein

the intermediate layer and the surface plate are bonded via the double-sided pressure-sensitive adhesive sheet according to any one of [1] to [5].

[9]: A surface plate with a polishing pad, comprising:

a polishing member in which a polishing pad and an intermediate layer are bonded via a first double-sided pressure-sensitive adhesive sheet; and a surface plate bonded to the polishing member via a second double-sided pressure-sensitive adhesive sheet, wherein

the first double-sided pressure-sensitive adhesive sheet and the second double-sided pressure-sensitive adhesive sheet are each independently the double-sided pressure-sensitive adhesive sheet according to any one of [1] to [5].

The present disclosure is a double-sided pressure-sensitive adhesive sheet for polishing, and can provide the double-sided pressure-sensitive adhesive sheet that can develop strong pressure-sensitive adhesive force from a room temperature to high temperatures and can develop sufficient holding force for a long time at high temperatures, a polishing member, and a surface plate with a polishing pad. Furthermore, the present disclosure can provide a double-sided pressure-sensitive adhesive sheet for polishing that has excellent pressure-sensitive adhesive force and cohesive force as before storage and has excellent temporal stability even when stored for a long time in a high-temperature environment or a high-temperature and high-humidity environment, a polishing member, and a surface plate with a polishing pad.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF THE DRAWINGS

FIG. 1 is a schematic cross-sectional view showing an example of a double-sided pressure-sensitive adhesive sheet according to the present embodiment;

FIG. 2 is a schematic view showing an example of a polishing member according to the present embodiment;

FIG. 3 is a schematic view showing an example of a surface plate with a polishing pad according to the present embodiment;

FIG. 4 is a schematic view showing another example of a polishing member according to the present embodiment; and

FIG. 5 is a schematic view for describing a method of holding force test in the present embodiment.

### DETAILED DESCRIPTION OF THE EMBODIMENTS

Hereinafter, an example of an embodiment to which the present disclosure is applied will be described. Other embodiments are also included in the scope of the present disclosure as long as they are consistent with the gist of the present disclosure. In addition, the numerical range specified by using “-” in the present description includes the numerical values described before and after “-”. In addition, various components appearing in the present description may be each independently used singly or in combination of two or more, unless otherwise specified. In addition, the numerical values specified in the present description are values obtained by the method disclosed in Examples. In addition, in the figure, the same element members are designated by the same reference numerals.

FIG. 1 shows a schematic cross-sectional view of an example of the double-sided pressure-sensitive adhesive sheet of the present embodiment (hereinafter, also referred to as the present double-sided pressure-sensitive adhesive sheet). A double-sided pressure-sensitive adhesive sheet 10 includes a sheet-shaped base material 3, a first pressure-sensitive adhesive layer 1 provided on a first main surface 4 of the sheet-shaped base material 3, and a second pressure-sensitive adhesive layer 2 provided on a second main surface 5 on the side opposite to the first main surface 4 of the sheet-shaped base material 3. Hereinafter, the first pressure-sensitive adhesive layer and the second pressure-sensitive adhesive layer are collectively referred to as each pressure-sensitive adhesive layer. This double-sided pressure-sensitive adhesive sheet is particularly preferable for bonding a polishing pad to a surface plate, bonding a polishing member having a polishing pad to a surface plate, or forming a polishing member.

Both the first pressure-sensitive adhesive layer and the second pressure-sensitive adhesive layer are each independent, or any one of the first pressure-sensitive adhesive layer and the second pressure-sensitive adhesive layer is a pressure-sensitive adhesive layer that is formed from a pressure-sensitive adhesive including an acrylic-based copolymer (A), a tackifier resin (B), and an isocyanate compound (C) and having a gel fraction of 5 to 50% by mass.

The acrylic-based copolymer (A) will be described.

The acrylic-based copolymer (A) is a copolymer of radically polymerizable monomers.

The radically polymerizable monomers include n-butyl (meth)acrylate, alkyl (meth)acrylate having 6 to 9 carbon atoms in the alkyl group, a radically polymerizable monomer having a carboxy group, and a radically polymerizable monomer having a hydroxyalkyl group. There are included 56% by mass or more of n-butyl (meth)acrylate, 1 to 5% by mass of the radically polymerizable monomer having a carboxy group, and 0.01 to 0.3% by mass of the radically polymerizable monomer having a hydroxyalkyl group in 100% by mass of the radically polymerizable monomers.

<n-Butyl (Meth)Acrylate>

Examples of the n-butyl (meth)acrylate include n-butyl acrylate and n-butyl methacrylate, and n-butyl acrylate is preferable.

The n-butyl (meth)acrylate is included in an amount of 56% by mass or more, preferably 60 to 70% by mass, and more preferably 62 to 68% by mass in 100% by mass of the radically polymerizable monomers.

Including it in an amount of 56% by mass or more allows a well-balanced development of pressure-sensitive adhesive force and cohesive force suitable for a polishing member, and a well-balanced development of pressure-sensitive adhesive force and cohesive force suitable for fixing a polishing pad or a polishing member to a surface plate.

### <Alkyl (Meth)Acrylate Having 6 to 9 Carbon Atoms in Alkyl Group>

Examples of the alkyl (meth)acrylate having 6 to 9 carbon atoms in the alkyl group include hexyl (meth)acrylate, 2-ethylhexyl (meth)acrylate, octyl (meth)acrylate, and nonyl (meth)acrylate. Of these, 2-ethylhexyl acrylate is preferable.

In addition, the alkyl (meth)acrylate having 6 to 9 carbon atoms in the alkyl group is preferably included in an amount of 20 to 30% by mass, more preferably 22 to 28% by mass, in 100% by mass of the radically polymerizable monomers.

### <Radically Polymerizable Monomer Having Carboxy Group>

A radically polymerizable monomer having a carboxy group may be any monomer having a carboxy group, and examples thereof include (meth)acrylic acid, itaconic acid, and maleic acid, and (meth)acrylic acid is preferable. These monomers may be used singly or in combination of two or more.

The radically polymerizable monomer having a carboxy group is included in the range of 1 to 5% by mass in 100% by mass of the radically polymerizable monomers, allowing the crosslink density between the acrylic-based copolymer (A) and the isocyanate compound (C) to be easily controlled, and allowing a balance between pressure-sensitive adhesive force and cohesive force to be easily obtained. From the above viewpoint, the radically polymerizable monomer having a carboxy group is preferably included in an amount of 1.2 to 4.5% by mass, more preferably 1.5 to 3.5% by mass.

### <Radically Polymerizable Monomer Having Hydroxyalkyl Group>

In the present disclosure, it is important to use 0.01 to 0.3% by mass of a radically polymerizable monomer having a hydroxyalkyl group. In addition, it is important to use 90 to 100% by mass of the radically polymerizable monomer having a hydroxyalkyl group that has 3 or less carbon atoms in 100% by mass of the radically polymerizable monomers having a hydroxyalkyl group. The acrylic-based copolymer (A) including such a radically polymerizable monomer as a copolymer component can easily control the density of crosslink with the curing agent and easily provide a balance between pressure-sensitive adhesive force and cohesive force to a polishing pad, an intermediate layer, and a surface plate.

Examples of the radically polymerizable monomer having a hydroxyalkyl group that has 3 or less carbon atoms include 2-hydroxyethyl (meth)acrylate and 3-hydroxypropyl (meth)acrylate, and of these, 2-hydroxyethyl (meth)acrylate is more preferable, and 2-hydroxyethyl acrylate is particularly preferable, from the viewpoint of appropriate crosslinkability with the isocyanate compound (C). These monomers may be used singly or in combination of two or more.

When the radically polymerizable monomer having a hydroxyalkyl group that has 3 or less carbon atoms is used, the crosslink density does not become too high, and a balance between pressure-sensitive adhesive force and cohesive force can be obtained. When the radically polymerizable monomer having a hydroxyalkyl group that has 4 or more of carbon atoms is used in combination with the radically polymerizable monomer having a hydroxyalkyl group that has 3 or less carbon atoms, the monomer having 3 or less carbon atoms in the hydroxyalkyl group is preferably included in an amount of 90% by mass or more, and more preferably 95% by mass or more, in 100% by mass of the radically polymerizable monomers having a hydroxyalkyl group. It is more preferable to use 100% by mass of the radically polymerizable monomer having 3 or less carbon atoms in the hydroxyalkyl group.

Other radically polymerizable monomers for forming the acrylic-based copolymer (A) include methyl (meth)acrylate, ethyl (meth)acrylate, propyl (meth)acrylate, (meth)acrylamide, and vinyl acetate, acrylic nitrile, and styrene, and these monomers can be used appropriately.

For the copolymerization of the acrylic-based copolymer (A), a conventionally known polymerization initiator can be used such as a peroxide polymerization initiator or an azobis-based polymerization initiator. Examples of the organic peroxide polymerization initiator include benzoyl peroxide, di-t-butyl peroxide, cumene hydroperoxide, t-butyl peroxybenzoate, t-butyl peroxyneodecanoate, and t-butylperoxy2-ethylhexanoate. Examples of the azobis-based polymerization initiator include 2,2′-azobisisobutyronitrile, 2,2′-azobis(2-amidinopropane)dihydrochloride, 2,2′-azobis[2-(5-methyl-2-imidazolin-2-yl)propane]dihydrochloride, 2,2′-azobis(2-methylpropion amidine)disulfate, and 2,2′-azobis(N,N′-dimethyleneisobutyramidine). These polymerization initiators may be used singly or in combination of two or more.

It is important that the weight average molecular weight of the acrylic-based copolymer (A) is 600000 or more, preferably 600000 to 1400000, more preferably 700000 to 1300000. Setting it in the above range can provide a good balance between pressure-sensitive adhesive force and cohesive force suitable for forming a polishing member and for fixing a polishing pad and a polishing member to a surface plate.

In the present disclosure, the weight average molecular weight is the polystyrene-equivalent weight average molecular weight obtained by GPC measurement, and the GPC measurement conditions are as follows.

Equipment: SHIMADZU Prominence (manufactured by Shimadzu Corporation)
Column: TOSOH TSK-GEL GMHXL (manufactured by Tosoh Corporation) is used.
Solvent: tetrahydrofuran, flow rate: 0.5 mL/min, Temperature: 40° C., sample concentration: 0.1 wt %, sample injection volume: 100

### <Tackifier Resin (B)>

The pressure-sensitive adhesive in the present disclosure contains the tackifier resin (B).

Including the tackifier resin (B) can keep tackiness and heat resistance appropriate in a well-balanced manner.

Examples of the tackifier resin include: rosin-based resins such as rosin esters, polymerized rosins, hydrogenated rosins, disproportionated rosins, maleic acid-modified rosins, fumaric acid-modified rosins, and rosin phenolic resins; terpene-based resins such as α-pinene resin, β-pinene resin, dipentene resin, aromatic-modified terpene resin, hydrogenated terpene resin, terpene phenol-based resin, acid-modified terpene resin, and styrenated terpene resin; petroleum-based hydrocarbon resins such as C5 aliphatic hydrocarbon resins, C9 aromatic hydrocarbon resins, hydrogenated C9 hydrocarbon resins, C5-C9 copolymer resins, and dicyclopentadiene hydrocarbon resins; kumaron-inden resins; styrene-based resins; alkylphenol resins; and xylene resins. Of these, the terpene phenol-based resin or the rosin-based resin is preferable. Using either one of the above two tackifier resins can maintain tackiness and heat resistance in a well-balanced manner. The rosin-based resin is preferably a rosin ester, and the rosin ester is more preferably a polymerized rosin ester.

Examples of the terpene phenol-based resin include SylVaresTP95 (manufactured by Arizona Chemical Co., Ltd., softening point 95±5° C.), SylVaresTP105 (manufactured by Arizona Chemical Co., Ltd., softening point 105±5° C.), SylVaresTP115 (manufactured by Arizona Chemical Co., Ltd., softening point 115±5° C.), YS Polystar U115 (manufactured by Yasuhara Chemical Co., Ltd., softening point 115±5° C.), YS Polystar T80 (manufactured by Yasuhara Chemical Co., Ltd., softening point 80±5° C.), YS Polystar T100 (manufactured by Yasuhara Chemical Co., Ltd., softening point 100±5° C.), YS Polystar T115 (manufactured by Yasuhara Chemical Co., Ltd., softening point 115±5° C.), YS Polystar T130 (manufactured by Yasuhara Chemical Co., Ltd., softening point 130±5° C.), and YS Polystar T145 (manufactured by Yasuhara Chemical Co., Ltd., softening point 145±5° C.).

The polymerized rosin ester is a product obtained by esterifying the polymerized rosin (a dimer of rosin) with glycerin or pentaerythritol, and from the viewpoint of adhesion to a polishing pad, an intermediate layer, and a polishing member, the softening point is preferably 135° C. or less, more preferably 90 to 130° C.

Examples of the polymerized rosin ester include Pencel D-125 (manufactured by Arakawa Chemical Co., Ltd., hydroxyl value: 30 to 40, softening point: 125° C.), Pencel D-135 (manufactured by Arakawa Chemical Co., Ltd., hydroxyl value 30 to 40, softening point: 135° C.), Pencel D-160 (manufactured by Arakawa Chemical Co., Ltd., hydroxyl value 30 to 40, softening point: 160° C.), Pine Crystal KE359 (manufactured by Arakawa Chemical Co., Ltd., hydroxyl value 38 to 47, softening point: 100° C.), and Pine Crystal D-6011 (manufactured by Arakawa Chemical Co., Ltd., hydroxyl value 110 to 125, softening point: 90° C.), but are not limited to these. Of these, the Pencel series (manufactured by Arakawa Chemical Co., Ltd.) is more preferable, and when transparency is required, the Pine Crystal series (manufactured by Arakawa Chemical Co., Ltd.) is preferable. These tackifier resins may be used singly or in combination of two or more.

The tackifier resin (B) is used in the range of 15 to 50 parts by mass and preferably in the range of 20 to 45 parts by mass with respect to 100 parts by mass of the acrylic-based copolymer (A). Using it at 15 parts by mass or more can improve the pressure-sensitive adhesive force to a polishing pad and a surface plate, and using it at 50 parts by mass or less can suppress a cohesive force reduction caused by the tackifier resin (B).

### <Isocyanate Compound (C)>

The pressure-sensitive adhesive in the present disclosure contains the isocyanate compound (C) of a tolylene diisocyanate trimethylolpropane adduct. Including tolylene diisocyanate trimethylolpropane adduct easily controls the crosslink density with the acrylic-based copolymer (A), and easily provides a balance between the pressure-sensitive adhesive force and the cohesive force to a polishing pad and a surface plate.

Furthermore, in the present disclosure, the isocyanate compound (C) is preferably used in the range of 0.5 to 2.5 parts by mass, more preferably 0.8 to 2.0 parts by mass, with respect to 100 parts by mass of the acrylic-based copolymer (A). Using it in the above range can impart a certain degree of crosslink suitable for forming a polishing member or for fixing a polishing pad or a polishing member to a surface plate.

In addition, other isocyanate compounds, aziridine compounds, metal chelate compounds, epoxy compounds and the like other than the tolylene diisocyanate trimethylolpropane adduct (C) can be used in combination.

Examples of other isocyanate compounds include tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethylxylylene diisocyanate, naphthalene diisocyanate, triphenylmethane triisocyanate, polyisocyanate compounds such as polymethylene polyphenyl isocyanate, and an adduct, burette, and isocyanurate of these isocyanate compounds and polyol compounds such as trimethylolpropane, and furthermore an adduct of these isocyanate compounds and known polyether polyols, polyester polyols, acrylic polyols, polybutadiene polyols, and polyisoprene polyols.

Examples of the aziridine compound include N,N′-hexamethylene-1,6-bis(1-aziridinecarboxamide), trimethylolpropane-tri-β-aziridinyl propionate, N,N′-diphenylmethane 4,4′-bis(1-aziridinecarboxamide), and trimethylolpropane-tri-β-(2-methylaziridine)propionate.

Examples of the epoxy compound include bisphenol A, epichlorohydrin type epoxy-based resin, ethylene glycidyl ether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidyl amine, N, N, N′, N′-tetraglycidyl-m-xylylenediamine, and 1,3-bis(N,N′-diamineglycidylaminomethyl)cyclohexane.

These curing agents may be used in combination with the isocyanate compound (C), or may be used in combination of two or more.

### <Other Additives>

Furthermore, the present disclosure may include other additives such as fillers, pigments, dyes, diluents, polymerization inhibitors, UV absorbers, UV stabilizers, and coupling agents, blended with known pressure-sensitive adhesives as necessary. One or two or more of additives are used. In addition, the amount of the additive added may be an amount that can provide the required physical properties, and is not particularly limited.

### <Double-Sided Pressure-Sensitive Adhesive Sheet>

As a method for producing a pressure-sensitive adhesive sheet, a pressure-sensitive adhesive is prepared. The same pressure-sensitive adhesive may be used, or different pressure-sensitive adhesives may be used for the first pressure-sensitive adhesive layer and the second pressure-sensitive adhesive layer. The prepared pressure-sensitive adhesives are applied to release liners to form each pressure-sensitive adhesive layer. Then, there can be exemplified a method (1) in which the respective pressure-sensitive adhesive layers are bonded to both surfaces of the sheet-shaped base material. In addition, the following method can be exemplified as a method (2). That is, a pressure-sensitive adhesive is applied onto one surface of the sheet-shaped base material to form the first pressure-sensitive adhesive layer, and then the release liner is bonded thereto to provide a first laminate of a sheet-shaped base material/first pressure-sensitive adhesive layer/release liner layer. Separately, the same or different pressure-sensitive adhesives are applied onto the release liner to form the second pressure-sensitive adhesive layer to provide a second laminate of the release liner layer/second pressure-sensitive adhesive layer. Then, a double-sided pressure-sensitive adhesive sheet can be produced by a method of bonding the second pressure-sensitive adhesive layer onto a surface of the sheet-shaped base material on which the first pressure-sensitive adhesive layer is not formed. Each pressure-sensitive adhesive layer is typically protected by the release liner until just before the double-sided pressure-sensitive adhesive sheet is used.

Each pressure-sensitive adhesive can be applied by using known methods such as roll coater method, comma coater method, lip coater method, die coater method, reverse coater method, silk screen method, and gravure coater method. After application, drying can be performed with, for example, a hot air oven and an infrared heater.

The thickness of each pressure-sensitive adhesive layer is each independently preferably 10 to 150 μm, more preferably 20 to 100 μm. The thickness of each pressure-sensitive adhesive layer within the above range can provide an excellent pressure-sensitive adhesive sheet as a pressure-sensitive adhesive sheet for forming a polishing member, or a pressure-sensitive adhesive sheet for fixing a polishing member or a polishing pad to a surface plate.

### <Gel Fraction>

In the present disclosure, the gel fraction of each pressure-sensitive adhesive layer is each independently in the range of 5 to 50% by mass, preferably in the range of 10 to 45% by mass. The gel fraction having 5% by mass or more can provide a cohesive force suitable as a pressure-sensitive adhesive sheet for fixing to a surface plate, and the gel fraction having 50% by mass or less can easily provide a balance between pressure-sensitive adhesive force and cohesive force to a polishing pad or a polishing member. The method for measuring the gel fraction can be obtained by the method described in Examples.

In the present disclosure, various plastic films can be preferably used as the sheet-shaped base material. Examples of the plastic film include not only polyolefin films such as polyethylene and polypropylene and polyester films such as polyethylene terephthalate, but also a film of polyphenylene sulfide (PPS), polyamide, triacetyl cellulose, cycloolefin, and polyimide.

In addition, the sheet-shaped base material may be subjected to an easily bonding treatment in order to enhance the adhesion to each pressure-sensitive adhesive layer. The easily bonding treatment is performed by using known methods such as a dry method for corona discharge and a wet method for applying an anchor coating agent, and of these, corona treatment is preferable. Using a film with the surface being subjected to the easily bonding treatment improves the adhesion with each pressure-sensitive adhesive layer, thus allowing provision of a pressure-sensitive adhesive sheet in which each pressure-sensitive adhesive layer is hard to peel off from the sheet-shaped base material.

In addition, an antistatic sheet-shaped base material having an antistatic layer can be used as the sheet-shaped base material. The antistatic sheet-shaped base material can be formed by applying an antistatic agent to the sheet-shaped base material. There is preferable a composition obtained by blending, with a resin, at least any one of conductive carbon particles, conductive metal particles, and conductive polymer, in addition to the antistatic agent, as necessary. In addition, the antistatic layer can be formed by subjecting the sheet-shaped base material to metal vapor deposition or metal plating.

In the present disclosure, the thickness of the sheet-shaped base material is not particularly limited, and is preferably 5 to 300 μm, more preferably 20 to 200 μm, from the viewpoint of handleability and cost reduction.

The release liner has a release layer formed by applying a release agent to a base material such as paper, plastic film, or synthetic paper. Examples of the release agent include silicone, alkyd resin, melamine resin, fluororesin, and acrylic resin. The thickness of the release liner is not particularly limited, and is about 10 to 200 μm.

### <Double-Sided Pressure-Sensitive Adhesive Sheet for Forming Polishing Member>

The present double-sided pressure-sensitive adhesive sheet is preferably used for forming a polishing member.

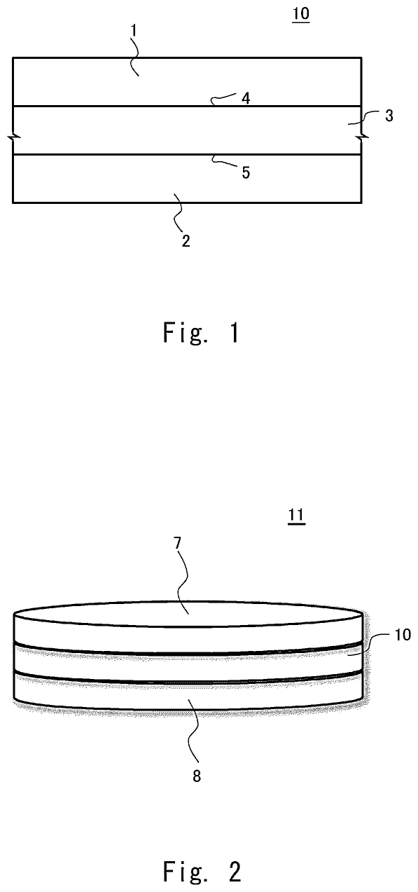

FIG. 2 shows a schematic view showing an example of a polishing member according to the present embodiment. In the polishing member 11, a polishing pad 7 that comes into direct contact with the polishing target and an intermediate layer 8 are bonded via a double-sided pressure-sensitive adhesive sheet 10. The polishing member may have another layer.

Examples of the polishing pad include a polyurethane foam sheet and a non-woven fabric, and the foaming state, hardness, thickness, and the like can be appropriately selected according to type of polishing target and the state thereof and the target polishing state.

Examples of the intermediate layer include polyurethane foam sheets, non-woven fabric, and a polyolefin foam sheet.

### <Double-Sided Pressure-Sensitive Adhesive Sheet for Bonding Polishing Member to Surface Plate or for Bonding Polishing Pad to the Surface Plate>

The present double-sided pressure-sensitive adhesive sheet is preferably used for bonding a polishing member to a surface plate or for bonding a polishing pad to a surface plate.

As described above, the polishing member has a configuration in which a polishing pad and an intermediate layer are laminated via a double-sided pressure-sensitive adhesive sheet. The intermediate layer and the surface plate of the polishing member can be bonded (fixed) via a double-sided pressure-sensitive adhesive sheet. As this double-sided pressure-sensitive adhesive sheet, the same or different double-sided pressure-sensitive adhesive sheet for forming a polishing member can be used.

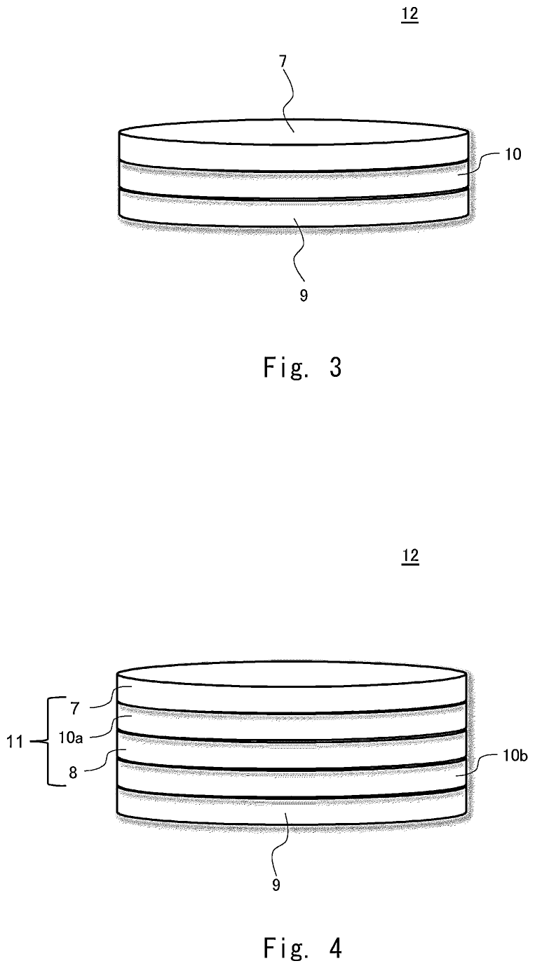

FIG. 3 shows a schematic view showing an example of a surface plate with a polishing pad 12 according to the present embodiment. A polishing pad 7 and a surface plate 9 are bonded via a double-sided pressure-sensitive adhesive sheet 10.

FIG. 4 shows a schematic view showing another example of the surface plate with a polishing pad 12 according to the present embodiment. This includes a polishing member 11 to which the polishing pad 7 and an intermediate layer 8 are bonded via a first double-sided pressure-sensitive adhesive sheet 10a, and the surface plate 9 bonded via a polishing member 11 and a second double-sided pressure-sensitive adhesive sheet 10b. The present double-sided pressure-sensitive adhesive sheet is each independently used for the first double-sided pressure-sensitive adhesive sheet 10a and the second double-sided pressure-sensitive adhesive sheet 10b. The surface plate with a polishing pad 12 may have other members. Examples of the surface plate include stainless steel, glass, alumina ceramics, silicon carbide, and Teflon.

To bond the polishing member to the surface plate, the pressure-sensitive adhesive layer on one surface of the double-sided pressure-sensitive adhesive sheet for fixing is bonded to the intermediate layer side of the polishing member, and then the pressure-sensitive adhesive layer on the other surface of the double-sided pressure-sensitive adhesive sheet for fixing can be bonded to the surface plate, or the pressure-sensitive adhesive layer on one surface of the double-sided pressure-sensitive adhesive sheet for fixing is bonded to the surface plate, and then the pressure-sensitive adhesive layer on the other surface of the double-sided pressure-sensitive adhesive sheet for fixing can be bonded to the intermediate layer side of the polishing member.

Similarly, to bond the polishing pad to the surface plate, the pressure-sensitive adhesive layer on one surface of the double-sided pressure-sensitive adhesive sheet for fixing is bonded to the polishing pad, and then the pressure-sensitive adhesive layer on the other surface of the double-sided pressure-sensitive adhesive sheet for fixing can be bonded to the surface plate, or the pressure-sensitive adhesive layer on one surface of the double-sided pressure-sensitive adhesive sheet for fixing is bonded to the surface plate, and then the pressure-sensitive adhesive layer on the other surface of the double-sided pressure-sensitive adhesive sheet for fixing can be bonded to the polishing pad.

### EXAMPLES

Hereinafter, the present disclosure will be described in more detail with reference to Examples; however, the present disclosure is not limited to the following Examples. In the Examples, “parts” means “parts by mass” and “%” means “% by mass.”

### <Synthesis Example 1> Acrylic-Based Copolymer (A-1)

In a 4-neck flask equipped with a stirrer, a thermometer, a reflux condenser, a dropping device, and a nitrogen introduction tube, under a nitrogen atmosphere, there were charged 32.5 parts by mass of n-butyl acrylate, 12.5 parts by mass of 2-ethylhexyl acrylate, 3.35 parts by mass of ethyl acrylate, 1.6 parts by mass of acrylic acid, 0.05 parts by mass of 2-hydroxyethyl acrylate, and appropriate amounts of ethyl acetate as a solvent and azobisisobutyronitrile as an initiator. Separately, in a dropping tube, there were charged 32.5 parts by mass of n-butyl acrylate, 12.5 parts by mass of 2-ethylhexyl acrylate, 3.35 parts by mass of ethyl acrylate, 1.6 parts by mass of acrylic acid, 0.05 parts by mass of 2-hydroxyethyl acrylate, and appropriate amounts of ethyl acetate as a solvent and azobisisobutyronitrile as a polymerization initiator to prepare a monomer solution.

Then, the flask was gradually heated, and after confirming the start of the reaction, the monomer solution was added dropwise from the dropping tube over 1 hour. Furthermore, the reaction was continued for 8 hours at an internal temperature of about 80° C. After completion of the reaction, the mixture was cooled and diluted with ethyl acetate to provide a solution of an acrylic-based copolymer (A-1) having a weight average molecular weight of 950000.

### <Synthesis Examples 2 to 6, 101 to 103> Acrylic-Based Copolymers (A-2) to (A-6) and (A-101) to (A-103)

As shown in Table 1, the acrylic-based copolymers (A-2) to (A-6) and (A-101) to (A-103) were obtained in the same manner as the acrylic-based copolymer (A-1), except that the type and amount of the radically polymerizable monomer having a hydroxyalkyl group were changed. The amount of the monomer in the flask and the dropping tube was the same as in Synthesis Example 1; however, the total amount is shown in Table 1.

### <Synthesis Examples 7 to 11, 104 to 105> Acrylic-Based Copolymers (A-7) to (A-11) and (A-104) to (A-105)

As shown in Table 1, acrylic-based copolymers (A-7) to (A-11) and (A-104) to (A-105) were obtained in the same manner as the acrylic-based copolymer (A-1), except that the amounts of n-butyl acrylate, 2-ethylhexyl acrylate, and ethyl acrylate were changed.

### <Synthesis Examples 12 to 16, 106> Acrylic-Based Copolymers (A-12) to (A-16) and (A-106)

According to the composition shown in Table 2, acrylic-based copolymers (A-12) to (A-16) and (A-106) having different weight average molecular weights were obtained in the same manner as the acrylic-based copolymer (A-1), except that the amount of a polymerization initiator was changed.

### <Synthesis Examples 17 to 20, 107 to 108> Acrylic-Based Copolymers (A-17) to (A-20) and (A-107) to (A-108)

According to the composition shown in Table 2, acrylic-based copolymers (A-17) to (A-20) and (A-107) to (A-108) were obtained in the same manner as the acrylic-based copolymer (A-1), except that the amount of acrylic acid was changed.

### Example 1

With respect to 100 parts by mass of the acrylic-based copolymer (A-1) obtained in Synthesis Example 1, 30 parts by mass of Pencel D-125 (manufactured by Arakawa Chemical Co., Ltd., polymerized rosin ester-based resin, softening point: 125° C.), as the isocyanate compound (C), 1.3 parts by mass of a tolylene diisocyanate trimethylolpropane adduct, and an appropriate amount of ethyl acetate as a solvent were blended, and the mixture was stirred with a disper to provide a pressure-sensitive adhesive, and the gel fraction was determined according to the method described later.

The obtained pressure-sensitive adhesive was applied onto a surface of a 25 μm polyethylene terephthalate film (hereinafter referred to as PET film) so that the thickness after drying was 60 μm, drying at 100° C. for 2 minutes was performed to form the pressure-sensitive adhesive layer 1, and a release liner was bonded thereto to provide PET (sheet-shaped base material)/pressure-sensitive adhesive layer 1/release liner.

Separately, the obtained pressure-sensitive adhesive was applied onto a release liner so that the thickness after drying was 60 μm, and drying at 100° C. for 2 minutes was performed to form the pressure-sensitive adhesive layer 2 to provide pressure-sensitive adhesive layer 2/release liner.

Then, the pressure-sensitive adhesive layer 2 of pressure-sensitive adhesive layer 2/release liner was bonded to the other surface of the PET film of PET/pressure-sensitive adhesive layer 1/release liner, and this was left at 23° C. and 50% for 1 week, thereby providing a double-sided pressure-sensitive adhesive sheet in which 60 μm pressure-sensitive adhesive layers 1 and 2 were each provided on both surfaces of a 25 μm PET film and the pressure-sensitive adhesive layers 1 and 2 were each protected by the release liner. Pressure-sensitive adhesive force and holding force were determined according to the method described later.

### <Examples 2 to 20> and <Comparative Examples 1 to 8>

A pressure-sensitive adhesive was obtained in the same manner as in Example 1 except that the acrylic-based copolymers (A-2) to (A-20) and (A-101) to (A-108) were used instead of the acrylic-based copolymer (A-1), the gel fraction and the like was determined, and the pressure-sensitive adhesive force and holding force of the obtained double-sided pressure-sensitive adhesive sheet were determined.

### <Examples 21 to 32> and <Comparative Examples 9 to 13>

According to the composition shown in Table 4, a pressure-sensitive adhesive was obtained in the same manner as in Example 1 except that the type and amount of the tackifier resin were changed and the type and amount of the isocyanate compound were changed, and the gel fraction and the like were determined. In addition, the pressure-sensitive adhesive force and holding force of the obtained double-sided pressure-sensitive adhesive sheet were determined. The abbreviations in the table are as follows.

### [Acrylic Monomer]

BA: n-Butyl acrylate
2EHA: 2-Ethylhexyl acrylate
EA: Ethyl acrylate

### [Monomer Having Carboxyl Group]

AA: Acrylic acid

### [Monomer Having Hydroxy Group]

HEA: 2-Hydroxyethyl acrylate
2HEMA: 2-Hydroxyethyl methacrylate
4HBA: 4-Hydroxybutyl acrylate

### [Tackifier Resin]

Pencel D 125 (rosin ester resin manufactured by Arakawa Chemical Co., Ltd., hydroxyl value 30 to 40, softening point 125° C.)
Pencel D 160 (rosin ester resin manufactured by Arakawa Chemical Co., Ltd., hydroxyl value 30 to 40, softening point 160° C.)
YS Polysta T115 (terpene phenol resin manufactured by Yasuhara Chemical Co., Ltd., softening point 115±5° C.)
YS Polysta T145 (terpene phenol resin manufactured by Yasuhara Chemical Co., Ltd., softening point 145±5° C.)
FTR6100 (petroleum-based resin manufactured by Mitsui Chemicals Inc., softening point 95° C.)

### [Isocyanate Compound]

TDI-TMP adduct: Tolylene diisocyanate trimethylolpropane adduct
HDI-TMP adduct: Hexamethylene diisocyanate trimethylolpropane adduct
IPDI-TMP adduct: Isophorone diisocyanate trimethylolpropane adduct
XDI-TMP adduct: Xylylene diisocyanate trimethylolpropane adduct

### <Initial Pressure-Sensitive Adhesive Force to SUS (Under 23° C. and 50% RH Environment)>

The pressure-sensitive adhesive force between the pressure-sensitive adhesive layer 1 of the obtained double-sided pressure-sensitive adhesive sheet and a stainless steel plate was determined according to the following procedure.

That is, a release sheet on the pressure-sensitive adhesive layer 2 side of the obtained double-sided pressure-sensitive adhesive sheet was peeled off, and a 25 μm PET film 30 was bonded. Then, this sheet was cut into a width of 25 mm and a length of 100 mm, then the release sheet on the pressure-sensitive adhesive layer 1 side was peeled off, and a stainless steel plate was laminated. Then, this sheet was pressure-bonded at one stroke with a 2 kg roll and left for 24 hours in an atmosphere of 23° C. and 50% to prepare a sample for measurement. For the sample for measurement, the peeling force between the pressure-sensitive adhesive layer 1 and the stainless steel plate was measured under the conditions of a peeling angle of 180 degrees and a peeling speed of 0.3 m/min under a 23° C. and 50% RH environment, and the initial pressure-sensitive adhesive force was determined.

The pressure-sensitive adhesive force is required to be 10 N/25 mm or more, and more required to be 15 N/25 mm or more.

### <Initial Pressure-Sensitive Adhesive Force to Urethane Foam Sheet (Under 23° C. and 50% RH Environment)>

The pressure-sensitive adhesive force between the pressure-sensitive adhesive layer 1 of the obtained double-sided pressure-sensitive adhesive sheet and a urethane foam sheet (Nipperlay EXT manufactured by NHK SPRING Co., Ltd., thickness 1.0 mm, density 550 kg/m³) was determined according to the following procedure.

That is, a release sheet on the pressure-sensitive adhesive layer 2 side of the obtained double-sided pressure-sensitive adhesive sheet was peeled off, and a 25 μm PET film was bonded. Then, this sheet was cut into a width of 25 mm and a length of 100 mm, then the release sheet on the pressure-sensitive adhesive layer 1 side was peeled off, the urethane foam sheet was laminated, a heating laminator (manufactured by Tester Sangyo Co., Ltd.) was used for pressure-bonding at a heating roll temperature of 90° C., a pressure of 0.3 MPa, and a laminating speed of 1.5 M/min, and left for 24 hours to prepare a sample for measurement.

For the sample for measurement, the peeling force between the pressure-sensitive adhesive layer 1 and the urethane foam sheet was measured under the conditions of a peeling angle of 180 degrees and a peeling speed of 0.3 m/min under a 23° C. and 50% RH environment, and the initial pressure-sensitive adhesive force was determined.

The pressure-sensitive adhesive force is required to be 10 N/25 mm or more, and more required to be 15 N/25 mm or more.

<Pressure-Sensitive Adhesive Force after High-Temperature Storage to Urethane Foam Sheet (Under 23° C. and 50% RH Environment)>

The obtained pressure-sensitive adhesive sheet was stored under a 80° C. environment for 1000 hours, and then returned to a 23° C. and 50% RH environment, and in the same manner as the initial pressure-sensitive adhesive force measurement, the pressure-sensitive adhesive force of the pressure-sensitive adhesive sheet after high-temperature storage under a 23° C. and 50% RH environment was determined.

<Pressure-Sensitive Adhesive Force after High-Temperature and High-Humidity Storage to Urethane Foam Sheet (Under 23° C. and 50% RH Environment)>

The obtained pressure-sensitive adhesive sheet was stored in a 60° C. and 90% RH environment for 1000 hours, and then returned to a 23° C. and 50% RH environment, and in the same manner as the initial pressure-sensitive adhesive force measurement, the pressure-sensitive adhesive force of the pressure-sensitive adhesive sheet after high-temperature and high-humidity storage under a 23° C. and 50% RH environment was determined.

### <Initial Holding Force for SUS Plate (Under 80° C. Environment)>

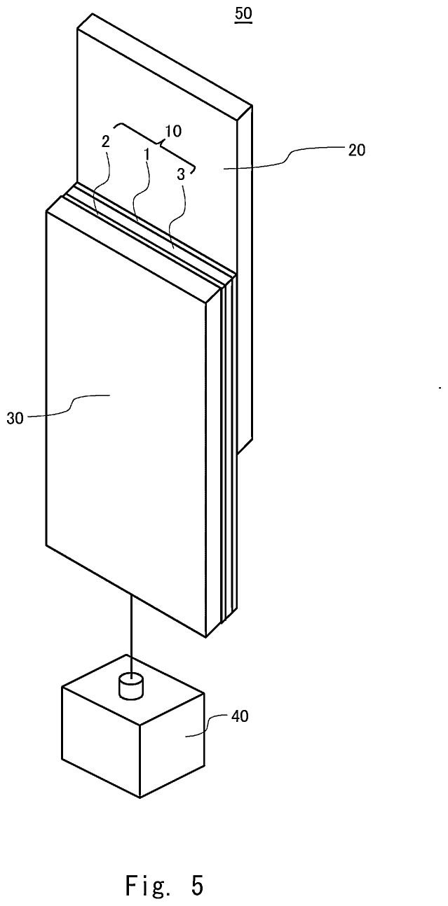

The holding force between the pressure-sensitive adhesive layer 1 of the obtained double-sided pressure-sensitive adhesive sheet and a stainless steel plate was determined according to the following procedure. This procedure will be described below with reference to the schematic view of FIG. 5.

A release sheet on the pressure-sensitive adhesive layer 2 side of the obtained double-sided pressure-sensitive adhesive sheet 10 was peeled off, and a 25 μm PET film 30 was bonded. Then, this sheet was cut into a width of 25 mm and a length of 100 mm, then the release sheet on the pressure-sensitive adhesive layer 1 side is peeled off. Then, the sheet and the stainless steel plate 20 were reciprocally pressure-bonded at with a 2 kg roll so that the sticking area had a width of 25 mm and a length of 25 mm. Then, this sheet was left for 20 minutes in a 23° C. and 50% atmosphere to provide a sample for measurement 50.

Under an 80° C. environment, a sample for measurement 50 was held vertically so that the stainless steel plate 20 was located at the upper part, and a load 40 of 1 kg was provided to the free end of the double-sided pressure-sensitive adhesive sheet 10 of the sample for measurement 50, and the deviation (mm) of the bonded position after 24 hours was measured. When the deviation was 25 mm or more within 24 hours, the pressure-sensitive adhesive sheet 10 wound fall. No fall was required, and more desirably the deviation was within 1 mm.

<Holding Force to SUS Plate after High-Temperature Storage (Under 80° C. Environment)>

The obtained double-sided pressure-sensitive adhesive sheet was stored under an 80° C. environment for 1000 hours and then returned to a 23° C. and 50%

RH environment. Then, in the same manner as in the initial holding force measurement, a sample for measurement was prepared, and the holding force of the pressure-sensitive adhesive sheet after high-temperature storage in an 80° C. environment was determined.

<Holding Force to SUS Plate after High-Temperature and High-Humidity Storage (Under 80° C. Environment)>

The obtained double-sided pressure-sensitive adhesive sheet was stored in a 60° C. and 90% RH environment for 1000 hours, and then returned to a 23° C. and 50% RH environment, and in the same manner as the initial holding force measurement, the holding force of the pressure-sensitive adhesive sheet after high-temperature and high-humidity storage in an 80° C. environment was determined.

### <Gel Fraction of Pressure-Sensitive Adhesive Layer>

A pressure-sensitive adhesive was applied onto a 50 μm release sheet so that the thickness after drying was 10 μm, drying at 100° C. for 2 minutes, and then another release liner was bonded to provide a laminate in which both surfaces of the pressure-sensitive adhesive layer were covered with the release sheet. Then, the obtained laminate was cut into a width of 30 mm and a length of 100 mm to prepare a sample.

The release liner on one surface of the obtained sample was peeled off, the sample was bonded to a weighed 300 mesh stainless steel wire mesh (mass W0), the release liner on the other side of the sample was peeled off, and then the sample bonded to the stainless wire mesh was weighed (mass W1). The sample bonded to the stainless wire mesh was reflux-extracted in ethyl acetate for 5 hours, dried at 100° C. for 1 hour, and the weighed mass (W2) was measured to calculate the gel fraction.

Gel fraction (% by mass)=[(W2−W0)/(W1−W0)]×100

TABLE 1
Examples of synthesis of acrylic-based copolymer

| | | | Synthesis | Synthesis | Synthesis | Synthesis | Synthesis | Synthesis | Synthesis | Synthesis | Synthesis |
|---|---|---|---|---|---|---|---|---|---|---|---|
| | | | example 1 | example 2 | example 101 | example 102 | example 3 | example 4 | example 5 | example 6 | example 103 |
| | | | (A-1) | (A-2) | (A-101) | (A-102) | (A-3) | (A-4) | (A-5) | (A-6) | (A-103) |
| Raw | Radically | BA | 65.00 | 65.00 | 65.00 | 65.10 | 65.09 | 65.07 | 64.85 | 64.80 | 64.70 |
| material | polymerizable | 2EHA | 25.00 | 25.00 | 25.00 | 25.00 | 25.00 | 25.00 | 25.00 | 25.00 | 25.00 |
| parts by | polymer | EA | 6.70 | 6.70 | 6.70 | 6.70 | 6.70 | 6.70 | 6.70 | 6.70 | 6.70 |
| mass | | AA | 3.20 | 3.20 | 3.20 | 3.20 | 3.20 | 3.20 | 3.20 | 3.20 | 3.20 |
| | | HEA | 0.10 | — | — | — | 0.01 | 0.3 | 0.25 | 0.30 | 0.40 |
| | | 2HEMA | — | 0.10 | — | — | — | — | — | — | — |
| | | 4HBA | — | — | 0.10 | — | — | — | — | — | — |

| | | | | | | | | | |
|---|---|---|---|---|---|---|---|---|---|
| Weight average molecular weight | 95 | 95 | 95 | 96 | 93 | 95 | 95 | 98 | 94 |
| (x10000) | | | | | | | | | |

| | | | Synthesis | Synthesis | Synthesis | Synthesis | Synthesis | Synthesis | Synthesis |
|---|---|---|---|---|---|---|---|---|---|
| | | | example 104 | example 7 | example 8 | example 9 | example 10 | example 11 | example 105 |
| | | | (A-104) | (A-7) | (A-8) | (A-9) | (A-10) | (A-11) | (A-105) |
| Raw | Radically | BA | 55.00 | 60.00 | 62.00 | 68.00 | 70.00 | 75.00 | 90.00 |
| material | polymerizable | 2EHA | 35.00 | 30.00 | 28.00 | 22.00 | 20.00 | 15.00 | 0.00 |
| parts by | polymer | EA | 6.70 | 6.70 | 6.70 | 6.70 | 6.70 | 6.70 | 6.70 |
| mass | | AA | 3.20 | 3.20 | 3.20 | 3.20 | 3.20 | 3.20 | 3.20 |
| | | HEA | 0.10 | 0.10 | 0.10 | 0.10 | 0.10 | 0.10 | 0.10 |
| | | 2HEMA | — | — | — | — | — | — | — |
| | | 4HBA | — | — | — | — | — | — | — |

| | | | | | | | |
|---|---|---|---|---|---|---|---|
| Weight average molecular weight | 88 | 90 | 95 | 95 | 98 | 100 | 108 |
| (x10000) | | | | | | | |

TABLE 2
Examples of synthesis of acrylic-based copolymer

| | | | Synthesis | Synthesis | Synthesis | Synthesis | Synthesis | Synthesis |
|---|---|---|---|---|---|---|---|---|
| | | | example 106 | example 12 | example 13 | example 14 | example 15 | example 16 |
| | | | (A-106) | (A-12) | (A-13) | (A-14) | (A-15) | (A-16) |
| Raw | Radically | BA | 65.00 | 67.20 | 66.70 | 63.70 | 63.20 | 65.00 |
| material | polymerizable | 2EHA | 25.00 | 25.00 | 25.00 | 25.00 | 25.00 | 25.00 |
| parts by | polymer | EA | 6.70 | 6.70 | 6.70 | 6.70 | 6.70 | 6.70 |
| mass | | AA | 3.20 | 1.00 | 1.50 | 4.50 | 5.00 | 3.20 |
| | | HEA | 0.10 | 0.10 | 0.10 | 0.10 | 0.10 | 0.10 |
| | | 2HEMA | — | — | — | — | — | — |
| | | 4HBA | — | — | — | — | — | — |
| Weight average molecular weight | | | 50 | 60 | 70 | 130 | 145 | 160 |
| (x10000) | | | | | | | | |
| | | | Synthesis | Synthesis | Synthesis | Synthesis | Synthesis | Synthesis |
| | | | example 107 | example 17 | example 18 | example 19 | example 20 | example 108 |
| | | | (A-107) | (A-17) | (A-18) | (A-19) | (A-20) | (A-108) |
| Raw | Radically | BA | 68.20 | 67.20 | 66.70 | 63.70 | 63.20 | 62.20 |
| material | polymerizable | 2EHA | 25.00 | 25.00 | 25.00 | 25.00 | 25.00 | 25.00 |
| parts by | polymer | EA | 6.70 | 6.70 | 6.70 | 6.70 | 6.70 | 6.70 |
| mass | | AA | — | 1.00 | 1.50 | 4.50 | 5.00 | 6.00 |
| | | HEA | 0.10 | 0.10 | 0.10 | 0.10 | 0.10 | 0.10 |
| | | 2HEMA | — | — | — | — | — | — |
| | | 4HBA | — | — | — | — | — | — |

| | | | | | | |
|---|---|---|---|---|---|---|
| Weight average molecular weight | 88 | 92 | 93 | 95 | 99 | 98 |
| (x10000) | | | | | | |

TABLE 3

| | | | | Comparative | | | | | | Comparative | | | | | | | Comparative |
|---|---|---|---|---|---|---|---|---|---|---|---|---|---|---|---|---|---|
| | | Example | | Example | | Example | | | | Example | | Example | | | | | Example |
| | | 1 | 2 | 1 | 2 | 3 | 4 | 5 | 6 | 3 | 4 | 7 | 8 | 9 | 10 | 11 | 5 |
| Acrylic-based copolymer | | A-1 | A-2 | A-101 | A-102 | A-3 | A-4 | A-5 | A-6 | A-103 | A-104 | A-7 | A-8 | A-9 | A-10 | A-11 | A-105 |
| Pressure-sensitive adhesive force to SUS | | 25.0 | 25.0 | 25.0 | 33.0 | 30.0 | 28.0 | 22.0 | 20.0 | 16.0 | 19.0 | 28.0 | 27.0 | 23.0 | 21.0 | 20.0 | 23.0 |
| (N/25 mm) under 23° C. and 50% RH environment | | | | | | | | | | | | | | | | | |
| Pressure-sensitive | Initial | 20.0 | 20.0 | 7.0 | 24.0 | 24.0 | 23.0 | 13.0 | 11.0 | 4.0 | 8.0 | 24.0 | 23.0 | 16.0 | 14.0 | 9.0 | 5.0 |
| adhesive force to | Pressure-sensitive adhesive sheet | 18.0 | 18.0 | 7.0 | 22.0 | 22.0 | 21.0 | 12.0 | 10.0 | 5.0 | 8.0 | 23.0 | 21.0 | 15.0 | 12.0 | 9.0 | 5.0 |
| urethane foam sheet | after storage at 80° C. for 1000 | | | | | | | | | | | | | | | | |
| under 23° C. and 50% RH | hours | | | | | | | | | | | | | | | | |
| environment | Pressure-sensitive adhesive sheet | 18.0 | 18.0 | 7.0 | 22.0 | 22.0 | 21.0 | 12.0 | 10.0 | 4.0 | 7.0 | 22.0 | 20.0 | 15.0 | 13.0 | 9.0 | 5.0 |
| | after storage at 60° C. and 90% RH | | | | | | | | | | | | | | | | |
| | for 1000 hours | | | | | | | | | | | | | | | | |
| Holding force to SUS | Initial | 0.3 | 0.3 | 0.0 | 1.1 | 0.8 | 0.5 | 0.0 | 0.0 | 0.0 | 0.0 | 0.6 | 0.4 | 0.2 | 0.1 | 0.0 | 0.0 |
| (daviation in mm, falling) | Pressure-sensitive adhesive sheet | 0.3 | 0.3 | 0.0 | Falling | 1.0 | 0.6 | 0.0 | 0.0 | 0.0 | 0.0 | 0.6 | 0.5 | 0.2 | 0.2 | 0.0 | 0.0 |
| under 80° C. environment | after storage at 80° C. for 1000 | | | | | | | | | | | | | | | | |
| and 1 kg load after 24 | hours | | | | | | | | | | | | | | | | |
| hours | Pressure-sensitive adhesive sheet | 0.4 | 0.4 | 0.0 | Falling | 1.0 | 0.7 | 0.0 | 0.0 | 0.0 | 0.0 | 0.6 | 0.5 | 0.2 | 0.2 | 0.1 | 0.0 |
| | after storage at 60° C. and 90% RH | | | | | | | | | | | | | | | | |
| | for 1000 hours | | | | | | | | | | | | | | | | |

| | | | | | | | | | | | | | | | | |
|---|---|---|---|---|---|---|---|---|---|---|---|---|---|---|---|---|
| Gel fraction (% by mass) | 32 | 34 | 59 | 3 | 5 | 8 | 45 | 49 | 58 | 50 | 28 | 30 | 34 | 38 | 40 | 50 |

| | | Comparative | | | | | | Comparative | | | | | Comparative |
|---|---|---|---|---|---|---|---|---|---|---|---|---|---|
| | | Example | Example | | | | | Example | Example | | | | Example |
| | | 6 | 12 | 13 | 14 | 15 | 16 | 7 | 17 | 18 | 19 | 20 | 8 |
| Acrylic-based copolymer | | A-106 | A-12 | A-13 | A-14 | A-15 | A-16 | A-107 | A-17 | A-18 | A-19 | A-20 | A-108 |
| Pressure-sensitive adhesive force to SUS | | 33.0 | 31.0 | 28.0 | 22.0 | 22.0 | 19.0 | 36.0 | 30.0 | 28.0 | 27.0 | 28.0 | 29.0 |
| (N/25 mm) under 23° C. and 50% RH environment | | | | | | | | | | | | | |
| Pressure-sensitive | Initial | 25.0 | 24.0 | 23.0 | 16.0 | 13.0 | 11.0 | 24.0 | 24.0 | 23.0 | 13.0 | 10.0 | 6.0 |
| adhesive force to | Pressure-sensitive adhesive sheet | 25.0 | 24.0 | 21.0 | 15.0 | 14.5 | 12.0 | 24.0 | 24.0 | 22.0 | 13.0 | 10.0 | 4.0 |
| urethane foam sheet | after storage at 80° C. for 1000 | | | | | | | | | | | | |
| under 23° C. and 50% RH | hours | | | | | | | | | | | | |
| environment | Pressure-sensitive adhesive sheet | 26.0 | 24.0 | 21.0 | 15.0 | 14.0 | 11.0 | 24.0 | 24.0 | 22.0 | 12.0 | 10.0 | 5.0 |
| | after storage at 60° C. and 90% RH | | | | | | | | | | | | |
| | for 1000 hours | | | | | | | | | | | | |
| Holding force to SUS | Initial | 1.2 | 0.8 | 0.5 | 0.1 | 0.0 | 0.0 | Falling | 0.8 | 0.5 | 0.0 | 0.0 | 0.0 |
| (daviation in mm, falling) | Pressure-sensitive adhesive sheet | Falling | 0.8 | 0.5 | 0.1 | 0.0 | 0.0 | Falling | 1.0 | 0.5 | 0.0 | 0.0 | 0.0 |
| under 80° C. environment | after storage at 80° C. for 1000 | | | | | | | | | | | | |
| and 1 kg load after 24 | hours | | | | | | | | | | | | |
| hours | Pressure-sensitive adhesive sheet | Falling | 1.0 | 0.6 | 0.1 | 0.0 | 0.0 | Falling | 1.0 | 0.6 | 0.0 | 0.0 | 0.0 |
| | after storage at 60° C. and 90% RH | | | | | | | | | | | | |
| | for 1000 hours | | | | | | | | | | | | |

| | | | | | | | | | | | | |
|---|---|---|---|---|---|---|---|---|---|---|---|---|
| Gel fraction (% by mass) | 1 | 5 | 16 | 38 | 43 | 50 | 6 | 6 | 9 | 42 | 48 | 55 |

* Acrylic-based copolymer:tackifier resin (Pencel D125):isocyanate compound (TDI-TMP adduct) = 100 parts:30 parts:1.3 parts

TABLE 4

| | | Example | | | | | | | | |
|---|---|---|---|---|---|---|---|---|---|---|
| | | 1 | 21 | 22 | 23 | 24 | 25 | 26 | 27 | 28 |
| Acrylic-based copolymer (A-1) | | 100 | | | | | 100 | | | |
| Tackifier resin | Pencel D125 | 30 | — | — | — | — | 15 | 20 | 45 | 50 |
| | Pencel D160 | — | 30 | — | — | — | — | — | — | — |
| | YS Polystar T115 | — | — | 30 | — | — | — | — | — | — |
| | YS Polystar T145 | — | — | — | 30 | — | — | — | — | — |
| | FTR6100 | — | — | — | — | 30 | — | — | — | — |
| Isocyanate compound | TDI-TMP adduct | 1.3 | | | | | 1.3 | | | |
| Pressure-sensitive adhesive force to SUS | | 25.0 | 24.0 | 26.0 | 24.0 | 26.0 | 20.0 | 23.0 | 28.0 | 30.0 |
| (N/25 mm) under 23° C. and 50% RH environment | | | | | | | | | | |
| Pressure-sensitive | Initial | 20.0 | 18.0 | 20.0 | 19.0 | 12.0 | 12.0 | 16.0 | 22.0 | 23.0 |
| adhesive force to | Pressure-sensitive adhesive sheet | 18.0 | 15.0 | 19.0 | 16.0 | 11.0 | 12.0 | 15.0 | 21.0 | 22.0 |
| urethane foam sheet | after storage at 80° C. for 1000 | | | | | | | | | |
| under 23° C. and 50% RH | hours | | | | | | | | | |
| environment | Pressure-sensitive adhesive sheet | 18.0 | 16.0 | 19.0 | 16.0 | 10.0 | 12.0 | 15.0 | 21.0 | 22.0 |
| | after storage at 60° C. and 90% RH | | | | | | | | | |
| | for 1000 hours | | | | | | | | | |
| Holding force to SUS | Initial | 0.3 | 0.2 | 0.3 | 0.2 | 0.3 | 0.0 | 0.1 | 0.5 | 0.8 |
| (difference in mm, falling) | Pressure-sensitive adhesive sheet | 0.3 | 0.2 | 0.3 | 0.2 | 0.3 | 0.0 | 0.1 | 0.5 | 0.8 |
| under 80° C. environment | after storage at 80° C. for 1000 | | | | | | | | | |
| and 1 kg load after 24 | hours | | | | | | | | | |
| hours | Pressure-sensitive adhesive sheet | 0.4 | 0.2 | 0.4 | 0.3 | 0.4 | 0.0 | 0.1 | 0.6 | 1.0 |
| | after storage at 60° C. and 90% RH | | | | | | | | | |
| | for 1000 hours | | | | | | | | | |

| | | | | | | | | | |
|---|---|---|---|---|---|---|---|---|---|
| Gel fraction (% by mass) | 32 | 33 | 38 | 42 | 38 | 50 | 45 | 9 | 5 |

| | | Example | | | | Comparative Example | | | | |
|---|---|---|---|---|---|---|---|---|---|---|
| | | 29 | 30 | 31 | 32 | 9 | 10 | 11 | 12 | 13 |
| Acrylic-based copolymer (A-1) | | 100 | | | | 100 | | | | |
| Tackifier resin (Pencel D125) | | 30 | | | | 5 | 60 | 30 | | |
| Isocyanate compound | TDI-TMP adduct | 0.5 | 0.8 | 2.0 | 2.5 | 1.3 | 1.3 | — | — | — |
| | HDI-TMP adduct | — | — | — | | — | — | 1.3 | — | — |
| | IPDI-TMP adduct | — | — | — | | — | — | — | 1.3 | — |
| | XDI-TMP adduct | — | — | — | | — | — | — | — | 1.3 |
| Pressure-sensitive adhesive force to SUS | | 30.0 | 28.0 | 23.0 | 20.0 | 16.0 | 34.0 | 35.0 | 25.0 | Unmeasurable |
| (N/25 mm) under 23° C. and 50% RH environment | | | | | | | | | | due to |
| Pressure-sensitive | Initial | 23.0 | 22.0 | 16.0 | 10.0 | 8.0 | 23.0 | 28.0 | 4.0 | adhesive |
| adhesive force to | Pressure-sensitive adhesive sheet | 22.0 | 21.0 | 15.0 | 10.0 | 6.0 | 23.0 | 24.0 | 4.0 | gelation |
| urethane foam sheet | after storage at 80° C. for 1000 | | | | | | | | | |
| under 23° C. and 50% RH | hours | | | | | | | | | |
| environment | Pressure-sensitive adhesive sheet | 22.0 | 21.0 | 15.0 | 10.0 | 6.0 | 23.0 | 24.0 | 4.0 | |
| | after storage at 60° C. and 90% RH | | | | | | | | | |
| | for 1000 hours | | | | | | | | | |
| Holding force to SUS | Initial | 0.8 | 0.5 | 0.1 | 0.0 | 0.0 | 1.0 | Falling | 0.0 | |
| (difference in mm, falling) | Pressure-sensitive adhesive sheet | 0.8 | 0.5 | 0.1 | 0.0 | 0.0 | Falling | Falling | 0.0 | |
| under 80° C. environment | after storage at 80° C. for 1000 | | | | | | | | | |
| and 1 kg load after 24 | hours | | | | | | | | | |
| hours | Pressure-sensitive adhesive sheet | 1.0 | 0.6 | 0.1 | 0.0 | 0.0 | Falling | Falling | 0.0 | |
| | after storage at 60° C. and 90% RH | | | | | | | | | |
| | for 1000 hours | | | | | | | | | |

| | | | | | | | | |
|---|---|---|---|---|---|---|---|---|
| Gel fraction (% by mass) | 5 | 8 | 38 | 45 | 56 | 2 | 0 | 42 |

As shown in Comparative Example 1 of Table 3, when a copolymer (A-101) obtained by copolymerizing 4-hydroxybutyl acrylate having 4 carbon atoms in the hydroxyalkyl group was used as the monomer having a hydroxy group, a pressure-sensitive adhesive sheet having excellent holding force in an 80° C. environment was able to be obtained; however, the pressure-sensitive adhesive force was inferior. Whereas, in Comparative Example 2 using a copolymer (A-102) without copolymerizing a monomer having a hydroxy group, the pressure-sensitive adhesive force was excellent; however, the holding force was inferior. In Comparative Example 3 with a copolymer (A-103) obtained by excessively copolymerizing 2-hydroxyethyl acrylate having 2 carbon atoms in the hydroxyalkyl group as the monomer having a hydroxy group, the holding force was excellent; however, the pressure-sensitive adhesive force was inferior.

In addition, in Comparative Example 4 with the case of a copolymer (A-104) having a significantly slightly low copolymerization ratio of n-butyl acrylate, the holding force was excellent; however, the pressure-sensitive adhesive force was inferior. When using a copolymer (A-105) without an alkyl (meth)acrylate having 6 to 9 carbon atoms in the alkyl group, the holding force was excellent; however, the pressure-sensitive adhesive force was inferior.

In Comparative Example 6 with an acrylic-based copolymer (A-106) having a small weight average molecular weight, the pressure-sensitive adhesive force was excellent; however, the holding force was inferior.

In Comparative Example 7 with a copolymer (A-107) without any radically polymerizable monomer having a carboxy group, the pressure-sensitive adhesive force was excellent; however, the holding force was inferior. In Comparative

Example 8 with a copolymer (A-108) obtained by excessively copolymerizing a radically polymerizable monomer having a carboxy group, the pressure-sensitive adhesive force was inferior.

As shown in Table 4, in Comparative Example 9 in which the amount of the tackifier resin was too small, the pressure-sensitive adhesive force was inferior, and in Comparative Example 10 in which the amount of the tackifier resin was too large, the holding force was inferior.

In addition, in Comparative Examples 11 to 13 with other isocyanate compounds instead of using tolylene diisocyanate trimethylolpropane adduct as a curing agent, the holding force was inferior and the pressure-sensitive adhesive gelled in about 30 minutes after mixing the curing agent, thus allowing no application.

Whereas, as shown in Examples 1 to 20, the double-sided pressure-sensitive adhesive sheet of the present disclosure had excellent pressure-sensitive adhesive force to a urethane foam sheet and excellent holding force to a SUS plate after all cases of initial storage, high-temperature storage, and high-temperature and high-humidity storage.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A double-sided pressure-sensitive adhesive sheet for bonding a polishing pad to a surface plate, for bonding a polishing member having the polishing pad to the surface plate, or for forming the polishing member, comprising:
a sheet-shaped base material;
a first pressure-sensitive adhesive layer provided on a first main surface of the sheet-shaped base material; and
a second pressure-sensitive adhesive layer provided on a second main surface of the sheet-shaped base material, wherein
both the first pressure-sensitive adhesive layer and the second pressure-sensitive adhesive layer are each independent, or any one of the first pressure-sensitive adhesive layer and the second pressure-sensitive adhesive layer is a pressure-sensitive adhesive layer that is formed from a pressure-sensitive adhesive including an acrylic-based copolymer, a tackifier resin, and an isocyanate compound, the pressure-sensitive adhesive layer having a gel fraction of 5 to 50% by mass,
the pressure-sensitive adhesive includes 15 to 50 parts by mass of the tackifier resin with respect to 100 parts by mass of the acrylic-based copolymer,
the acrylic-based copolymer is a copolymer of radically polymerizable monomers and having a weight average molecular weight of 600000 or more,
the radically polymerizable monomers include n-butyl (meth)acrylate, alkyl (meth)acrylate having 6 to 9 carbon atoms in an alkyl group, a radically polymerizable monomer having a carboxy group, and radically polymerizable monomers having a hydroxyalkyl group,
56% by mass or more of the n-butyl (meth)acrylate, 1 to 5% by mass of the radically polymerizable monomer having a carboxy group, and 0.01 to 0.3% by mass of the radically polymerizable monomers having a hydroxyalkyl group are included in 100% by mass of the radically polymerizable monomers,
90 to 100% by mass of a radically polymerizable monomer having a hydroxyalkyl group that has 3 or less carbon atoms is included in 100% by mass of the radically polymerizable monomers having a hydroxyalkyl group, and
the isocyanate compound is a tolylene diisocyanate trimethylolpropane adduct.

2. The double-sided pressure-sensitive adhesive sheet according to claim 1, wherein the pressure-sensitive adhesive includes 0.5 to 2.5 parts by mass of the isocyanate compound with respect to 100 parts by mass of the acrylic-based copolymer.

3. The double-sided pressure-sensitive adhesive sheet according to claim 1, wherein a weight average molecular weight of the acrylic-based copolymer is 600000 to 1400000.

4. The double-sided pressure-sensitive adhesive sheet according to claim 1, wherein the tackifier resin includes a polymerized rosin ester, and
50 to 100% by mass of the polymerized rosin ester is included in 100% by mass of the tackifier resin.

5. The double-sided pressure-sensitive adhesive sheet according to claim 4, wherein a softening point of the polymerized rosin ester is 135° C. or less.

6. A polishing member, comprising a polishing pad and an intermediate layer that are bonded via the double-sided pressure-sensitive adhesive sheet according to claim 1.

7. A surface plate with a polishing pad, wherein a polishing pad and a surface plate are bonded via the double-sided pressure-sensitive adhesive sheet according to claim 1.

8. A surface plate with a polishing pad, comprising:
a polishing member including a polishing pad and an intermediate layer; and a surface plate, wherein
the intermediate layer and the surface plate are bonded via the double-sided pressure-sensitive adhesive sheet according to claim 1.

9. A surface plate with a polishing pad, comprising:
a polishing member in which a polishing pad and an intermediate layer are bonded via a first double-sided pressure-sensitive adhesive sheet; and a surface plate bonded to the polishing member via a second double-sided pressure-sensitive adhesive sheet, wherein
the first double-sided pressure-sensitive adhesive sheet and the second double-sided pressure-sensitive adhesive sheet are each independently the double-sided pressure-sensitive adhesive sheet according to claim 1.
